(19) United States
(12) Patent Application Publication
(10) Pub. No.: US 2025/0243650 A1
(43) Pub. Date: Jul. 31, 2025

(54) DUAL-FUNCTION WATER SPRAY NOZZLE

(71) Applicant: XIAMEN DELMEI SANITARY WARE CO., LTD., XIAMEN (CN)

(72) Inventors: YUNAN HU, GANZHOU (CN); CHUNHUA WANG, XIAMEN (CN); CHANGZHENG NI, XIAMEN (CN); YONGQIANG YAN, FUZHOU (CN)

(21) Appl. No.: 18/768,019

(22) Filed: Jul. 10, 2024

(30) Foreign Application Priority Data
Jan. 29, 2024 (CN) 202410123951.1

(51) Int. Cl. E03C 1/04; E03C 1/084

(52) U.S. Cl. CPC E03C 1/0405; E03C 1/084

(57) ABSTRACT

A dual-function water spray nozzle includes a housing, a fixation member, an adjustment assembly, and an elastic member. The fixation member is connected to an interior of the housing, the fixation member has a water inlet channel extending through to an end, and a plurality of water passage ports in communication with the water inlet channel are provided. The adjustment assembly is movably arranged in an area between the housing and the fixation member. The adjustment assembly includes an adjustment joint and a switching member arranged in the adjustment joint. A first flow passage region is formed between the switching member and the fixation member, a second flow passage region is formed between the adjustment joint and the switching member, and the water passage ports are selectively connected to the first flow passage region or the second flow passage region. The elastic member enables the nozzle to restore.

### TECHNICAL FIELD

The present disclosure relates to the field of sanitary ware, in particular to a dual-function water spray nozzle.

### BACKGROUND

The water outlet hose of the faucet usually needs to be connected to a water nozzle. Currently, the water nozzles basically have only one outlet flow rate or one water spray setting. If different water flow rates or water spray settings are required, a shower head needs to be used. However, the structure of a shower head is relatively complicated and the cost is relatively high, which is not very user-friendly.

### SUMMARY

The present disclosure provides a dual-function water spray nozzle, which can effectively solve the above-mentioned problem.

The present disclosure is achieved by the following solutions.

A dual-function water spray nozzle, comprising:
a housing;
a fixation member, wherein the fixation member is connected to an interior of the housing, the fixation member has a water inlet channel extending through to an end of the fixation member, a plurality of water passage ports in communication with the water inlet channel, and a restriction surface situated at an end away from the water inlet channel;
an adjustment assembly, wherein the adjustment assembly is movably arranged in an area between the housing and the fixation member; the adjustment assembly comprises an adjustment joint arranged between the housing and the fixation member, and a switching member arranged in the adjustment joint, wherein an end of the switching member away from the restriction surface is provided with a stop surface; a first flow passage region is formed between the switching member and the fixation member, a second flow passage region is formed between the adjustment joint and the switching member, and the water passage ports are selectively connected to the first flow passage region or the second flow passage region; and an elastic member, wherein the elastic member is stretchably arranged between the restriction surface and the stop surface.

As a further improvement, the switching member is provided with an annular guide wall at an end of the stop surface, and a lower end surface of the guide wall is configured as a limiting plane; the guide wall and an inner sidewall of the switching member are spaced apart and the guide wall is connected to the stop surface, an accommodation area is formed between the guide wall and the inner sidewall of the switching member, and an end of the elastic member is accommodated in the accommodation area.

As a further improvement, the guide wall is movably arranged in an area between the fixation member and the housing, and the guide wall can contact the restriction surface.

As a further improvement, an inner sidewall of the switching member is provided with a first water outlet at an end away from the fixation member, and the first water outlet is connected to the first flow passage region.

As a further improvement, a sidewall surface of the fixation member at a side proximal to the restriction surface is provided with a plurality of adjustment holes, and the adjustment holes are connected to the first flow passage region and are connected to the first water outlet.

As a further improvement, an outer diameter of the restriction surface is complementary with an inner wall of the switching member.

As a further improvement, the first water outlet is provided with a third inner connection portion, the third inner connection portion is connected to an aerator, and the aerator is connected to the first flow passage region.

As a further improvement, an outer sidewall of the switching member at an end away from the fixation member is evenly provided with a plurality of second water outlets, and the second water outlets are connected to the second flow passage region.

As a further improvement, the water passage ports are arranged on a sidewall surface of the fixation member, and the fixation member is provided with third sealing rings sleeved on an outer wall surface at an upper side and a lower side of the water passage port.

As a further improvement, an inner sidewall of the adjustment joint is provided with an annular limiting step, an outer sidewall of the switching member is provided with a plurality of connection-engagement parts corresponding to the limiting step, and the connection-engagement parts are engaged with the limiting step to connect the adjustment joint with the switching member.

As a further improvement, an outer sidewall of the adjustment joint is provided with a plurality of sealing rings at a side close to the housing, and the first sealing rings are sealed and matched with an inner sidewall of the housing.

As a further improvement, the housing has an annular outer wall, an annular inner wall spaced apart with the annular outer wall, and a limiting plane connecting the annular outer wall and the annular inner wall, the annular outer wall is connected to an outer side of the annular inner wall, and the annular outer wall and the annular inner wall are both perpendicular to the limiting plane; the adjustment joint is movably arranged on an inner side of the annular outer wall and can be biased against the limiting plane.

As a further improvement, an inner sidewall of the annular inner wall is provided with a second inner connection portion, and an end of the fixation member away from the restriction surface is provided with a second outer connection portion, and the second inner connection portion and the second outer connection portion are connected to each other to connect the fixation member to the housing.

Alternatively, an inner sidewall and an outer sidewall of an end of the annular outer wall away from the adjustment assembly are respectively provided with a first inner connection portion and a first outer connection portion, and an upper end surface of the limiting plane is provided with a gasket, the first inner connection portion is connected to an external part and sealed through the gasket, or the first outer connection portion is connected to the external part.

As a further improvement, a water flow passage area of the adjustment holes of the fixation member matches the water flow passage area of the aerator of the first water outlet; after the adjustment joint is assembled in the dual-function water spray nozzle, the elastic member is compressed and thereby generates a preloading force, and when water flow is introduced a water inflow rate of the fixation member is set to be greater than a water outflow rate of the first water outlet, causing an internal pressure to form in the first flow passage region, and when the internal pressure is greater than the standard atmospheric pressure, the switching member installed with the aerator is arranged to generate a downward pressure along its axial direction, and the internal pressure generates an upward thrust on the stop surface and a restriction plane, and when the sum of the upward thrust and the preloading force is greater than the downward pressure, the sum of the upward thrust and the preloading force forces the switching member upward until the said sum of the upward thrust and the preloading force balances with the downward pressure, and thereby maintains the state of the switching member.

As a further improvement, when the adjustment joint is pulled downward, the restriction plane contacts the restriction surface, the elastic member is compressed to a maximum extent to generate an upward preloading force on the adjustment assembly; when water is introduced, the water inflow rate of the fixation member is set to be greater than the water outflow rate of the water outlet, the second flow passage region forms an internal pressure and pushes the adjustment assembly downward, the internal pressure offsets the preloading force to keep the adjustment assembly balanced.

As a further improvement, when the water inlet is shut off, the internal pressure of the second flow passage region disappears, and the elastic member pushes against the switching member to move upward until the adjustment joint is biased against the limiting plane to stop moving and get restored and maintained thereat.

The present disclosure has the following advantages: the fixation member is connected to the housing, and the combination of the housing and the fixation member is movably connected to the adjustment assembly, so as to form two selectable flow passage regions, and then two water spray settings are formed to meet the user's needs. The water spray settings of the nozzle of the present disclosure are set as shower spray and aerated water spray, and the aerated water spray may be set as the initial water spray each time the valve is opened. When the nozzle is switched to the shower spray during use, the water nozzle is fixed by the preloading force of the elastic member. After use and the water inlet valve is closed, the water nozzle is restored to the initial water spray setting by the elastic force of the elastic member, namely, the aerated water spray setting still works the next time the valve is opened again. Further, as long as the aerator with different flow rates is used, different flow requirements can be met. By arranging the water outlet between the adjustment joint and the switching member, the demand for shower spray with large water flow can be met. By arranging inner and outer connection portions on the housing, and the inner and outer connection portions are set as double-threaded connection structures, the adaptability of the water nozzle is maximized.

### BRIEF DESCRIPTION OF THE DRAWINGS

In order to more clearly illustrate the technical solutions of the embodiments of the present disclosure, the drawings required for illustrating the embodiments will be briefly introduced below. It should be understood that the following drawings merely show some embodiments of the present disclosure and therefore should not be regarded as limiting the scope. For those of ordinary skill in the art, other related drawings can be obtained based on these drawings without paying creative effort.

FIG. 1 is an exploded view of an embodiment of the present disclosure.

FIG. 2 is an isometric view of a first state of an embodiment of the present disclosure.

FIG. 3 is a bottom view of the first state of the embodiment of the present disclosure.

FIG. 4 is a first cross-sectional view of the first state of the embodiment of the present disclosure.

FIG. 5 is a second cross-sectional view of the first state of the embodiment of the present disclosure.

FIG. 6 is a third cross-sectional view of the first state of the embodiment of the present disclosure.

FIG. 7 is an isometric view of a second state of the embodiment of the present disclosure.

FIG. 8 is a bottom view of the second state of the embodiment of the present disclosure.

FIG. 9 is a first cross-sectional view of the second state of the embodiment of the present disclosure.

FIG. 10 is a second cross-sectional view of the second state of the embodiment of the present disclosure.

FIG. 11 is a third cross-sectional view of the second state of the embodiment of the present disclosure.

FIG. 12 is an isometric cross-sectional view of a housing according to the embodiment of the present disclosure.

FIG. 13 is an isometric cross-sectional view of an adjustment joint according to the embodiment of the present disclosure.

FIG. 14 is an isometric cross-sectional view of a switching member according to the embodiment of the present disclosure.

FIG. 15 is an isometric cross-sectional view of a fixation member according to the embodiment of the present disclosure.

FIG. 16 is a first cross-sectional view of a first state of another embodiment of the present disclosure.

FIG. 17 is a second cross-sectional view of the first state of another embodiment of the present disclosure.

FIG. 18 is a third cross-sectional view of the first state of another embodiment of the present disclosure.

FIG. 19 is a first cross-sectional view of a second state of another embodiment of the present disclosure.

FIG. 20 is a second cross-sectional view of the second state of another embodiment of the present disclosure.

FIG. 21 is a third cross-sectional view of the second state of another embodiment of the present disclosure.

FIG. 22 is an isometric cross-sectional view of a switching member according to another embodiment of the present disclosure.

FIG. 23 is an isometric cross-sectional view of a fixation member according to another embodiment of the present disclosure.

The references numerals in the drawings are listed below:
11. housing; 111. annular outer wall; 112. annular inner wall; 113. limiting plane; 114. first outer connection portion; 115. first inner connection portion; 116. second inner connection portion; 12. gasket;
2. adjustment assembly; 21. switching member; 210. flow passage port; 211. first flow passage region; 212. stop surface; 213. second water outlet; 214. second flow passage region; 215. guide wall; 216. accommodation area; 217. third inner connection portion; 218. connection-engagement portion; 219. restriction plane; 22. adjustment joint; 221. first sealing groove; 222. anti-slip position; 223. limiting step; 23. first sealing ring; 24. aerator; 25. elastic member;
31. fixation member; 311. water passage port; 312. second sealing groove; 313. third sealing groove; 314. second outer connection portion; 315. restriction surface; 316. tool position; 317. water inlet channel; 318. adjustment hole; 32. second sealing ring; 33. third sealing ring.

### DETAILED DESCRIPTION OF THE EMBODIMENTS

In order to make the purpose, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are part of the embodiments of the present disclosure rather than all. Based on the embodiments of the present disclosure, all other embodiments obtained by those of ordinary skill in the art without creative effort should be considered as falling within the scope of protection of the present disclosure. Therefore, the following detailed description of the embodiments of the present disclosure illustrated in the drawings is not intended to limit the scope of the disclosure sought to be patented, but merely represents selected embodiments of the present disclosure.

In the description of the present disclosure, the terms “first” and “second” are used for descriptive purposes only and should not be understood as indicating or implying relative importance or implicitly indicating the number of the indicated technical features. Thus, a feature defined as “first” or “second” may explicitly or implicitly include one or more of the features. In the description of the present disclosure, the term “plurality” means two or more, unless otherwise clearly and specifically defined.

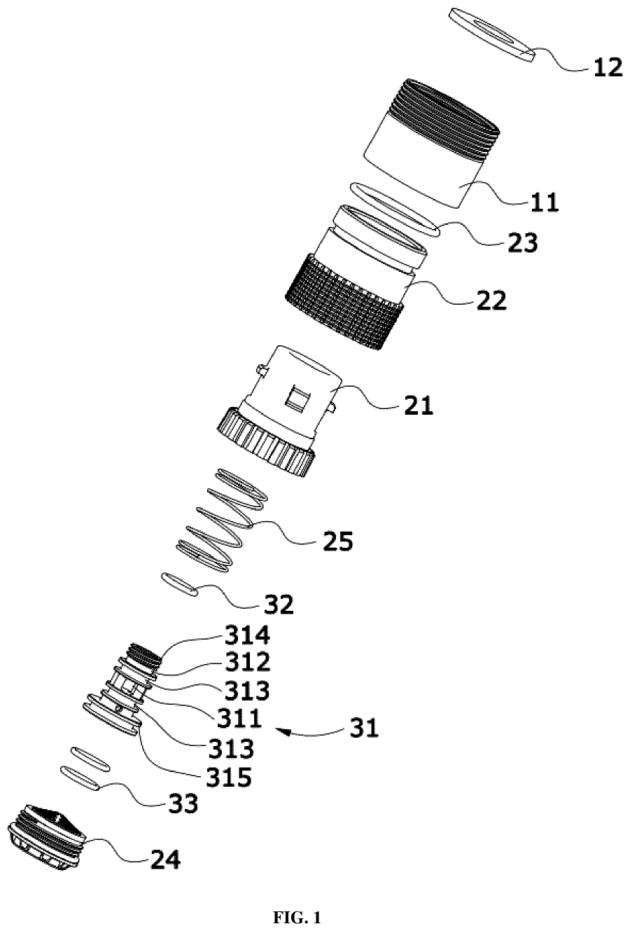

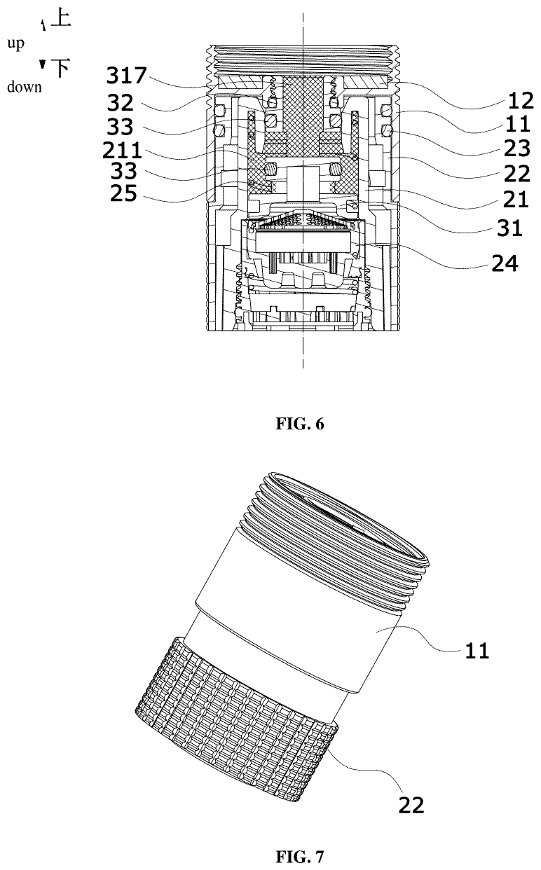

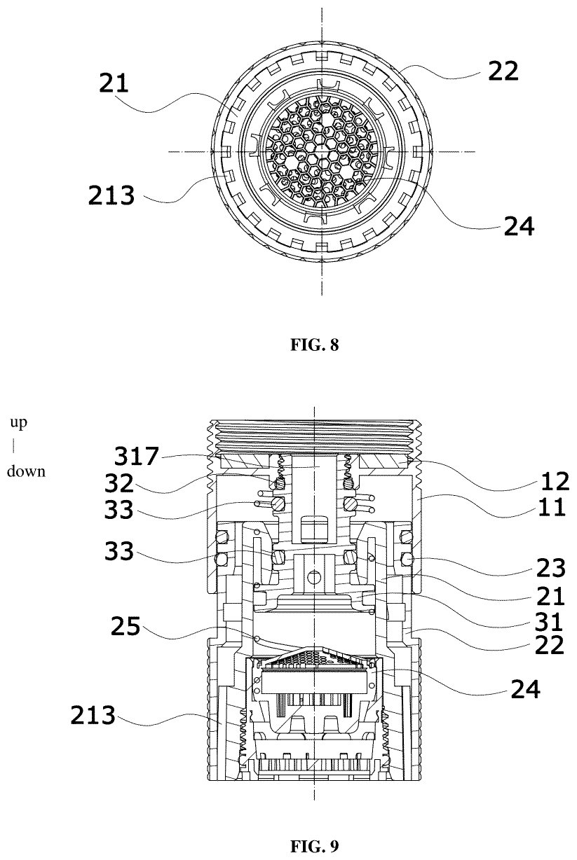

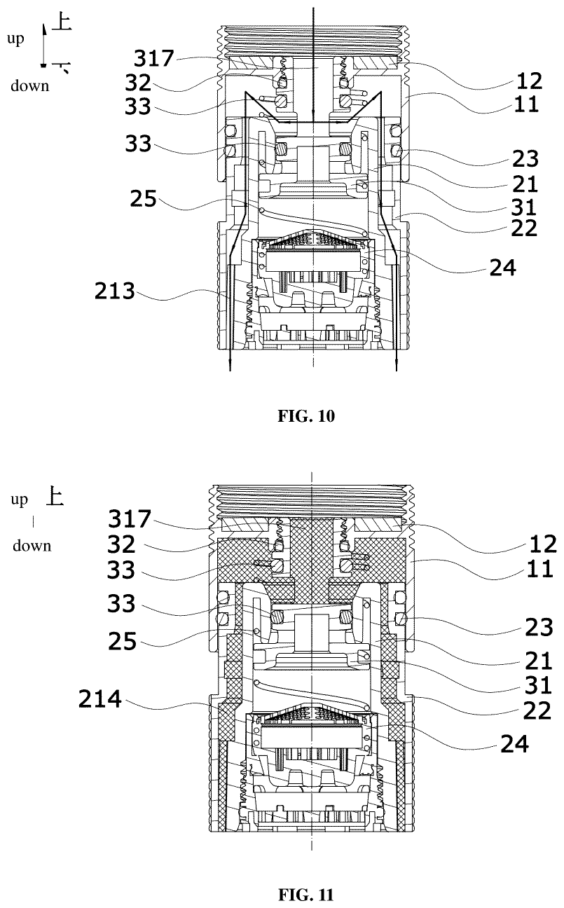

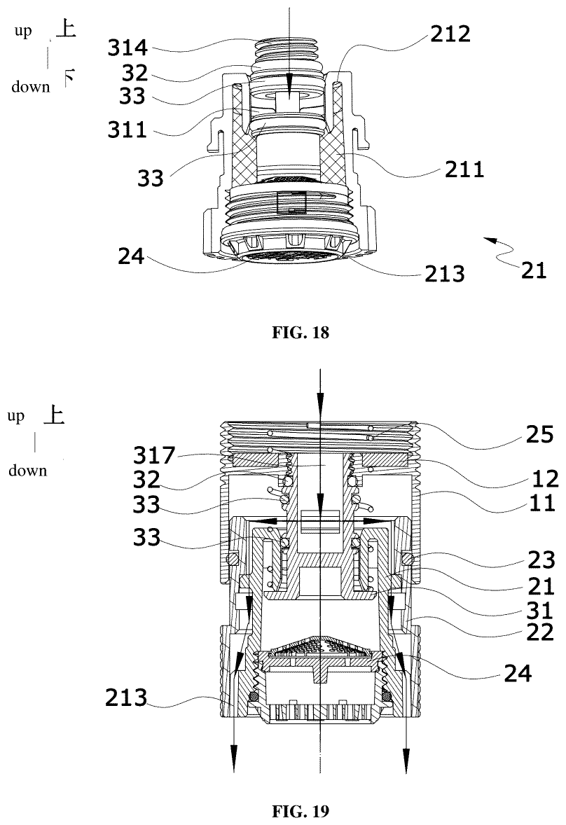

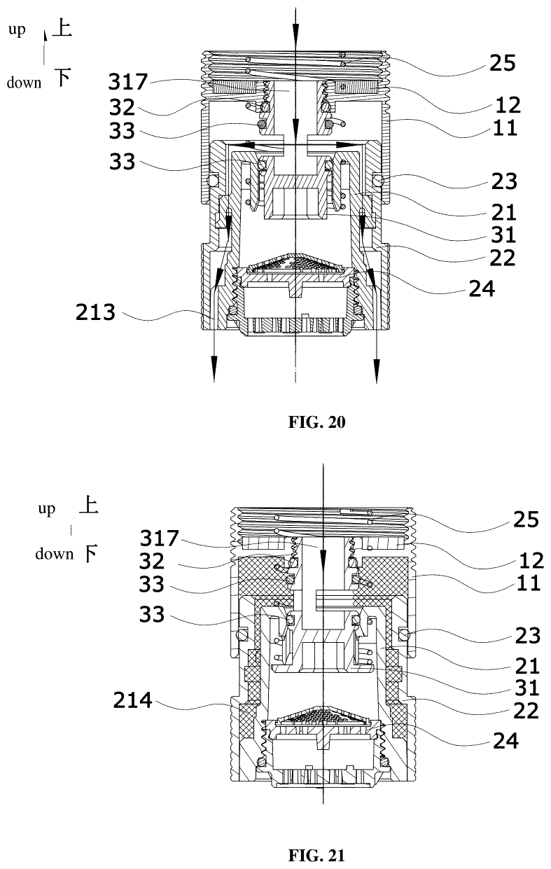

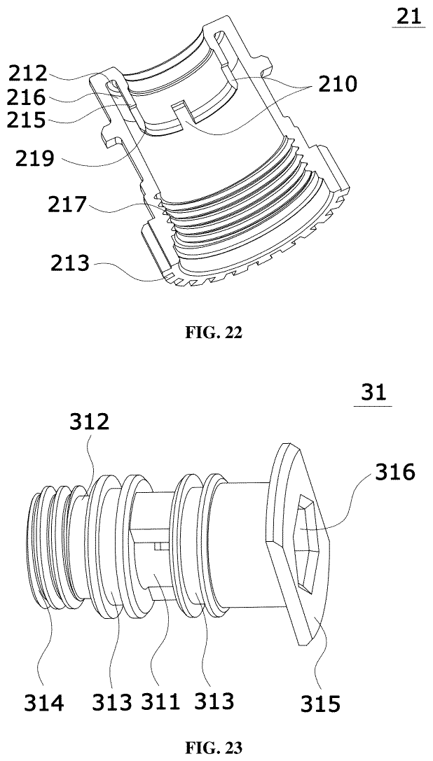

Referring to FIGS. 1-23, a dual-function water spray nozzle includes a housing 11, a fixation member 31 connected to an interior of the housing 11, and an adjustment assembly 2 movably arranged at a lower end of the housing 11 and the fixation member 31. When the adjustment assembly 2 gets close to a lower end surface of the housing 11, water flows out from the central part of the adjustment assembly 2. When the adjustment assembly 2 moves away from the lower end surface of the housing 11, water flows out from the outer periphery annular part of the adjustment assembly 2.

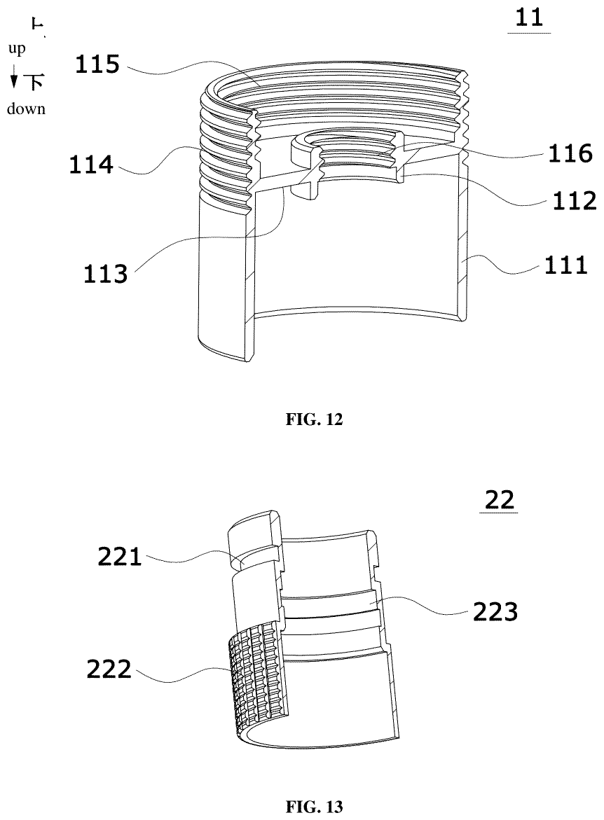

As shown in FIG. 12, the housing 11 has an annular outer wall 111, an annular inner wall 112 spaced apart from the annular outer wall 111, and a limiting plane 113 connecting the annular outer wall 111 and the annular inner wall 112. The annular outer wall 111 is connected to an outer side of the annular inner wall 112, and the annular outer wall 111 and the annular inner wall 112 are both perpendicular to the limiting plane 113. The limiting plane 113 is connected to an upper side of the annular outer wall 111 and a middle section of the annular inner wall 112, so that the annular inner wall 112 is located on the upper side of the annular outer wall 111. An inner sidewall and an outer sidewall of a side of the annular outer wall 111 proximal to an upper end surface of the annular outer wall 111 are respectively provided with a first outer connection portion 114 and a first inner connection portion 115, and a second inner connection portion 116 is provided on the inner sidewall of the annular inner wall 112. As shown in FIG. 15, a second outer connection portion 314 is provided on the upper end of the fixation member 31, and a second sealing groove 312 is provided below the second outer connection portion 314. A second sealing ring 32 is sleeved on the second sealing groove 312. The second outer connection portion 314 is connected to the second inner connection portion 116, and the second outer connection portion 314 and second inner connection portion 116 are sealed and matched through the second sealing ring 32, so that the fixation member 31 is sealed and connected to the housing 11.

An upper end surface of the limiting plane 113 is provided with a gasket 12, and the first inner connection portion 115 is configured to connect to an external component (not shown) and is sealed and matched with the external component through the gasket 12. Of course, the first outer connection portion 114 may also be configured to connect with the external component. In this embodiment, the first outer connection portion 114 and the second outer connection portion 314 are both configured as external thread structures, and the first inner connection portion 115 and the second inner connection portion 116 are both configured as internal thread structures. A tool position 316 concave upward is provided at a lower end of the fixation member 31. When the second outer connection portion 314 and the second inner connection portion 116 are connected, a tool is inserted into the tool position 316 and rotated to lock and fixedly connect the second outer connection portion 314 and the second inner connection portion 116.

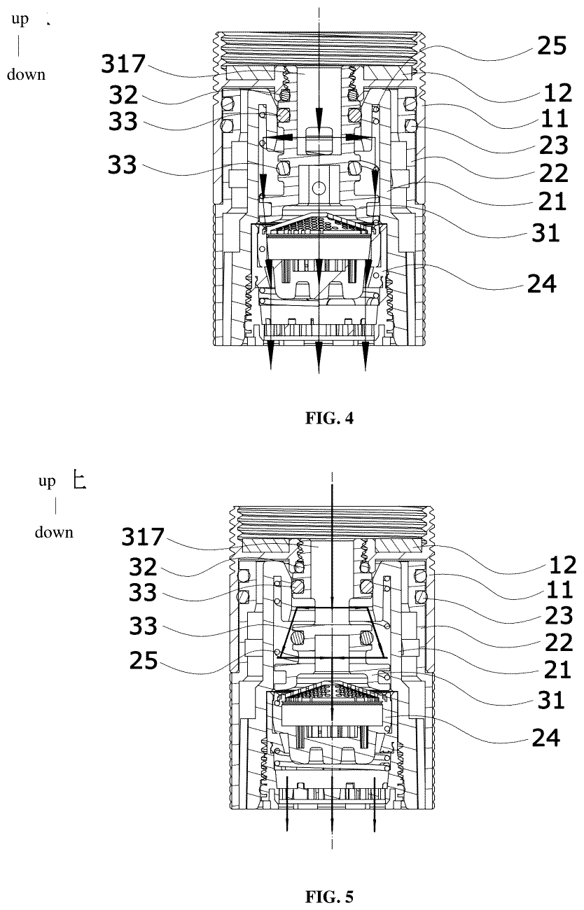

Referring to FIG. 1 and FIG. 15, the fixation member 31 has a water inlet channel 317 extending through upward and a water passage port 311 provided at a middle section of the sidewall of the water inlet channel 317. Two third sealing grooves 313 are provided on the outer wall surface of the fixation member 31. The two third sealing grooves 313 are respectively provided at the upper and lower sides of the water passage port 311. A third sealing ring 33 is sleeved on each of the third sealing grooves 313. Referring to FIGS. 4-6, when the adjustment assembly 2 gets close to the lower end surface of the housing 11, the two third sealing rings 33 and the water passage port 311 are both inserted into the central part of the adjustment assembly 2, and water flows from the water inlet channel 317 through the water passage port 311 and gets out from the central part of the adjustment assembly 2. Referring to FIGS. 9-11, when the adjustment assembly 2 gets away from the lower end surface of the housing 11, the third sealing ring 33 and the water passage port 311 on the upper side get away from an upper end surface of the central part of the adjustment assembly 2, and water flows from the water inlet channel 317 through the water passage port 311 and gets out from the outer periphery annular part of the adjustment assembly 2.

As shown in FIG. 1, the adjustment assembly 2 includes an adjustment joint 22 and a switching member 21 arranged in the adjustment joint 22. As shown in FIG. 13, at least one first sealing groove 221 is provided on an outer sidewall of a side of the adjustment joint 22 proximal to the housing 11. A first sealing ring 23 is sleeved on each of the first sealing grooves 221. The first sealing ring 23 is movable relative to an inner wall surface of a lower side of the housing 11 as the adjustment joint 22 moves. An anti-slip position 222 is provided on an outer sidewall of a side of the adjustment joint 22 away from the housing 11. When the user needs to adjust the adjustment joint 22, the user can control the adjustment joint 22 to move up and down by grasping on the anti-slip position 222.

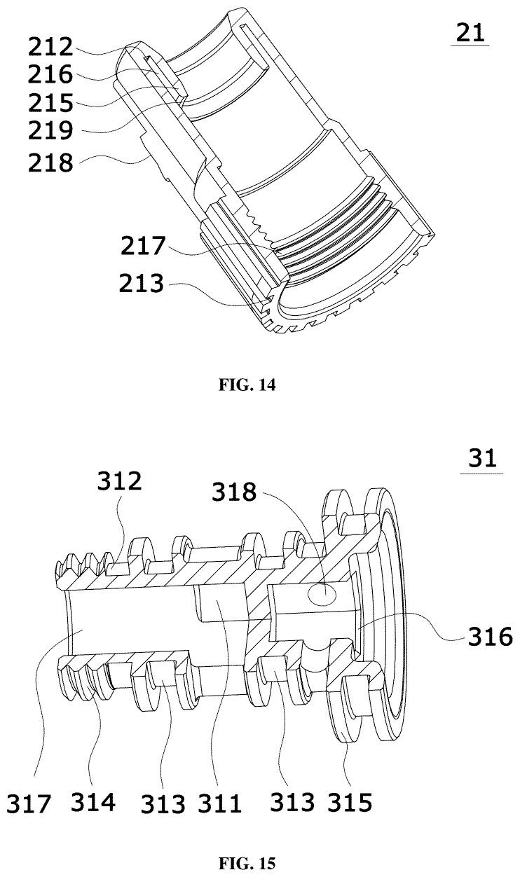

Referring to FIGS. 13 and 14, the middle section of the inner sidewall of the adjustment joint 22 is provided with upper and lower limiting steps 223, and the outer sidewall of the switching member 21 is provided with a plurality of connection-engagement portions 218 corresponding to the limiting steps 223, and the connection-engagement portions 218 are engaged with the limiting steps 223, so that the switching member 21 is clamped on the inner sidewall of the adjustment joint 22. In this embodiment, there are four connection-engagement portions 218, and the limiting steps 223 have an annular form. The four connection-engagement portions 218 are engaged with the limiting steps 223, so that the switching member 21 is connected to the adjustment joint 22.

As shown in FIG. 11, a second flow passage region 214 is formed between the outer sidewall of the switching member 21 and the inner sidewall of the adjustment joint 22, and the second flow passage region 214 is selectively connected with the water passage port 311. As shown in FIG. 14, a plurality of second water outlets 213 are evenly arranged at the lower end of the outer sidewall of the switching member 21, and the second water outlets 213 are connected with the second flow passage region 214. The sidewalls of the second water outlets 213 are fitted with the inner wall surface of the adjustment joint 22 by interference fit, so that water will not disperse and become disorderly when flowing through the second water outlets 213.

As shown in FIG. 14, a guide wall 215 is provided in an annular manner on a side of the upper end of the inner sidewall of the switching member 21, and the lower end surface of the guide wall 215 is configured as a restriction plane 219. As shown in FIG. 15, a restriction surface 315 is provided at the lower end of the fixation member 31, and the restriction surface 315 and the restriction plane 219 are relatively displaceable, and the guide wall 215 is restricted by the restriction surface 315.

The guide wall 215 and the inner sidewall of the switching member 21 are spaced apart to form an accommodation area 216 therebetween. A stop surface 212 is arranged on the inner side of the upper end surface of the switching member 21. The stop surface 212 is an inwardly concave structure. An elastic member 25 is arranged in the accommodation area 216. An end of the elastic member 25 is biased against the stop surface 212, and the other end of the elastic member 25 is biased against the restriction surface 315. In this embodiment, the elastic member 25 is a spring, and the spring moves between the stop surface 212 and the restriction surface 315. When the switching member 21 moves upward, a first flow passage region 211 is formed between the inner sidewall of the switching member 21 and the outer sidewall of the fixation member 31. The first flow passage region 211 is selectively connected with the water passage port 311. A first water outlet is arranged at an end of the inner sidewall of the switching member 21 away from the fixation member 31. The first water outlet is connected with the first flow passage region 211. The first water outlet is provided with a third inner connection portion 217, the third inner connection portion 217 is connected to an aerator 24, and the aerator 24 is connected to the first flow passage region 211.

As shown in FIG. 15, a plurality of adjustment holes 318 are provided on the sidewall surface of the fixation member 31 at a side proximal to the restriction surface 315, and the adjustment holes 318 are connected to the first flow passage region 211 and are connected to the water inlet end of the aerator 24. The outer diameter of the restriction surface 315 is complementary with the inner wall diameter of the switching member 21, and the sidewall of the restriction surface 315 is almost attached with the inner wall of the switching member 21, so that the water flow can only pass through the adjustment holes 318 but cannot pass through the area between the sidewall of the restriction surface 315 and the inner wall of the switching member 21. Of course, a sealing groove may be provided on the sidewall of the restriction surface 315 and a sealing member may be provided to seal the area between the sidewall of the restriction surface 315 and the inner wall of the switching member 21. Structures that can make sure that no water can flow through the area between the sidewall of the restriction surface 315 and the inner wall of the switching member 21 are falling within the protection scope of the present disclosure.

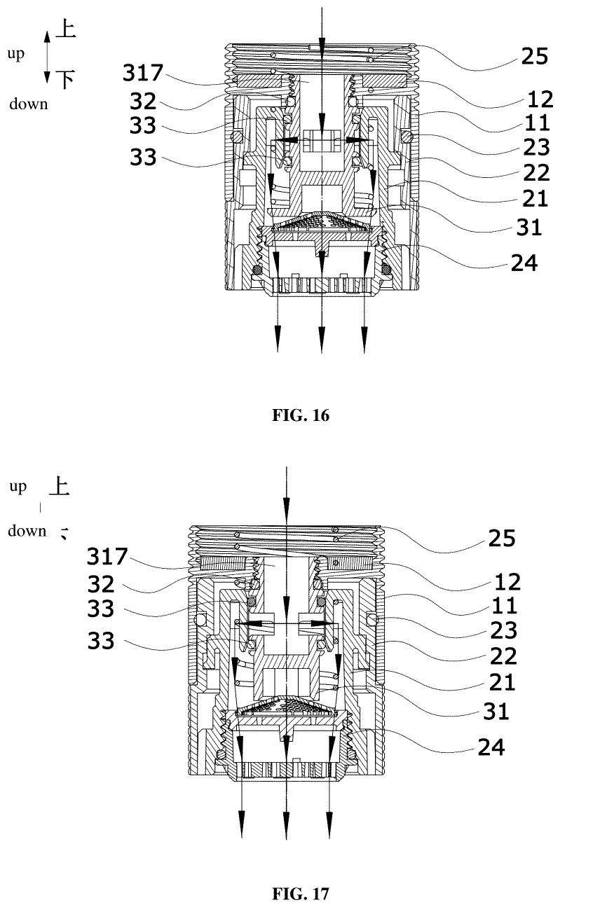

As shown in FIG. 16, under normal conditions, water flows through the water inlet channel 317 of the fixation member 31 to the first flow passage region 211, and then flows out through the aerator 24. The water spray is aerated, and the setting of aerated water is set as the initial water outlet setting of the water nozzle. At this time, the elastic member 25 is compressed, and the elastic member 25 generates a part of preloading force. When the external water inlet valve (not shown) is opened, the water flows through the first flow passage region 211 and then flows through the aerator 24 to discharge aerated water. When the water outflow rate of the aerator 24 is less than the water inflow rate, an internal pressure is formed in the first flow passage region 211. At this time, the internal pressure of the first flow passage region 211 is greater than the standard atmospheric pressure. The switching member 21 equipped with the aerator 24 will have a tendency to slide downward along the fixation member 31. However, due to the inwardly concave surface structure of the stop surface 212 and the restriction plane 219, when water enters, an upward thrust is generated on the stop surface 212 and the restriction plane 219. The switching member 21 can maintain balance only when the sum of the upward thrust and the preloading force of the elastic member 25 is greater than the downward pressure of the switching member 21. When the sum of the flow passage areas of the plurality of adjustment holes 318 matches the water outlet area of the aerator 24, no matter how much the inlet water pressure is, the upward thrust and the preloading force of the elastic member 25 can be balanced with the downward pressure of the switching member 21, thereby maintaining the state unchanged, that is, the tendency of sliding downward of the switching member 21 can be balanced.

Referring to FIGS. 7-11, when the water outlet setting of shower spray with a large flow rate is required, when the adjustment joint 22 is pulled downward, the water will flow through the water inlet channel 317 of the fixation member 31, then flow through the second flow passage region 214, and ultimately flow to the second water outlet 213 to discharge the shower spray. When the adjustment joint 22 is pulled downward, the elastic member 25 is compressed, at this time, the elastic member 25 is compressed to a maximum position as designed, so that the combination of the adjustment joint 22 and the switching member 21 has an upward preloading force. When water flows through the second flow passage region 214, since the water inflow rate of the fixation member 31 is set to be larger than the water outflow rate of the second water outlet 213, an internal pressure is formed in the second flow passage region 214, which can exactly offset the elastic force of the elastic member 25, so that the adjustment joint 22 remains balanced when water flows through the second water outlet 213.

When the water flow at the water inlet end is shut off, the internal pressure of the second flow passage region 214 disappears, and the balance of the adjustment joint 22 is broken. At this time, the elastic member 25 will push the switching member 21 to move upward until the adjustment joint 22 contacts the limiting plane 113 of the housing 11 to stop the upward movement, and the restoration is completed.

In another embodiment, as shown in FIGS. 16-23, a plurality of flow passage ports 210 are provided at intervals on the guide wall 215, and the flow passage ports 210 make the water passage ports 311 and the first flow passage region 211 communicate with each other, so that water flows from the water inlet channel 317 to the water passage ports 311, and flows to the first flow passage region 211 through the flow passage ports 210. In this embodiment, the sidewall surface of a side of the fixation member 31 proximal to the restriction surface 315 is not provided with the adjustment hole 318, and a gap is provided between the outer wall surface of the restriction surface 315 and the inner wall surface of the switching member 21. The gap enables the first flow passage region 211 and the first water outlet to communicate with each other, so that water can flow from the first flow passage region 211 through the gap to the first water outlet and flow out from the aerator 24 for use.

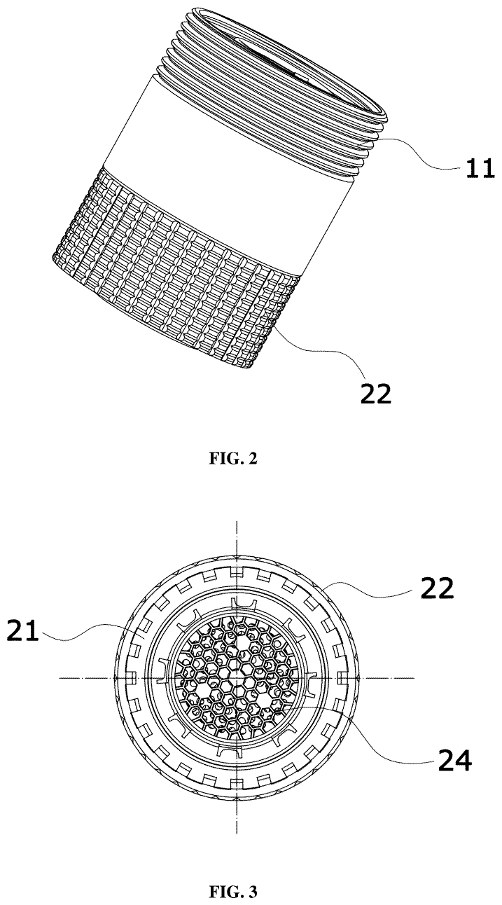

Referring to FIGS. 2-6, under normal conditions, water flows through the water inlet channel 317 of the fixation member 31, then flows through the first flow passage region 211, and ultimately flows out from the aerator 24. The water flow is aerated, and the aerated water spray is set as the initial water outlet setting of the water nozzle. At this time, the elastic member 25 is compressed, and the elastic member 25 generates a part of preloading force. When the external water inlet valve (not shown) is opened, the water flows through the first flow passage region 211 and then flows through the aerator 24 to discharge aerated water spray. When the water outflow rate of the aerator 24 is less than the water inflow rate, an internal pressure is formed in the first flow passage region 211. At this time, the internal pressure of the first flow passage region 211 is greater than the standard atmospheric pressure. The switching member 21 has a tendency to slide downward along the fixation member 31, but due to the inwardly concave surface of the stop surface 212, when water enters, an upward thrust is generated on the stop surface 212. At this time, no matter how much the water pressure of the water inlet is, the upward thrust and the preloading force of the elastic member 25 can balance the downward pressure of the switching member 21, thereby maintaining the state unchanged. Conditions where the setting of the shower spray with a large flow is required and where the water flow at the water inlet end needs to be shut off are the same as those in the previous embodiment, and will not be described in detail herein.

The above description merely includes preferred embodiment/s of the present disclosure and is not intended to limit the present disclosure. For those skilled in the art, the present disclosure may have various modifications and variations. Any modification, equivalent substitution, improvement, etc. made within the spirit and principle of the present disclosure shall be included in the protection scope of the present disclosure.

What is claimed is:

1. A dual-function water spray nozzle, characterized in that, the dual-function water spray nozzle comprises:
a housing;
a fixation member, wherein the fixation member is connected to an interior of the housing, the fixation member has a water inlet channel extending through to an end of the fixation member, a plurality of water passage ports in communication with the water inlet channel, and a restriction surface situated at an end away from the water inlet channel;
an adjustment assembly, wherein the adjustment assembly is movably arranged in an area between the housing and the fixation member; the adjustment assembly comprises an adjustment joint arranged between the housing and the fixation member, and a switching member arranged in the adjustment joint, wherein an end of the switching member away from the restriction surface is provided with a stop surface; a first flow passage region is formed between the switching member and the fixation member, a second flow passage region is formed between the adjustment joint and the switching member, and the water passage ports are selectively connected to the first flow passage region or the second flow passage region; and
an elastic member, wherein the elastic member is stretchably arranged between the restriction surface and the stop surface.

2. The dual-function water spray nozzle according to claim 1, characterized in that, the switching member is provided with an annular guide wall at an end of the stop surface, and a lower end surface of the guide wall is configured as a limiting plane; the guide wall and an inner sidewall of the switching member are spaced apart and the guide wall is connected to the stop surface, an accommodation area is formed between the guide wall and the inner sidewall of the switching member, and an end of the elastic member is accommodated in the accommodation area.

3. The dual-function water spray nozzle according to claim 2, characterized in that, the guide wall is movably arranged in an area between the fixation member and the housing, and the guide wall can contact the restriction surface.

4. The dual-function water spray nozzle according to claim 2, characterized in that, an inner sidewall of the switching member is provided with a first water outlet at an end away from the fixation member, and the first water outlet is connected to the first flow passage region.

5. The dual-function water spray nozzle according to claim 4, characterized in that, a sidewall surface of the fixation member at a side proximal to the restriction surface is provided with a plurality of adjustment holes, and the adjustment holes are connected to the first flow passage region and are connected to the first water outlet, and optionally an outer diameter of the restriction surface is complementary with a diameter of an inner wall of the switching member.

6. The dual-function water spray nozzle according to claim 5, characterized in that, the first water outlet is provided with a third inner connection portion, the third inner connection portion is connected to an aerator, and the aerator is connected to the first flow passage region.

7. The dual-function water spray nozzle according to claim 2, characterized in that, an outer sidewall of the switching member at an end away from the fixation member is evenly provided with a plurality of second water outlets, and the second water outlets are connected to the second flow passage region.

8. The dual-function water spray nozzle according to claim 1, characterized in that, the water passage ports are arranged on a sidewall surface of the fixation member, and the fixation member is provided with third sealing rings sleeved on an outer wall surface at an upper side and a lower side of the water passage port.

9. The dual-function water spray nozzle according to claim 1, characterized in that, an inner sidewall of the adjustment joint is provided with an annular limiting step, an outer sidewall of the switching member is provided with a plurality of connection-engagement parts corresponding to the limiting step, and the connection-engagement parts are engaged with the limiting step to connect the adjustment joint with the switching member.

10. The dual-function water spray nozzle according to claim 9, characterized in that, an outer sidewall of the adjustment joint is provided with a plurality of sealing rings at a side close to the housing, and the first sealing rings are sealed and matched with an inner sidewall of the housing.

11. The dual-function water spray nozzle according to claim 1, characterized in that, the housing has an annular outer wall, an annular inner wall spaced apart with the annular outer wall, and a limiting plane connecting the annular outer wall and the annular inner wall, the annular outer wall is connected to an outer side of the annular inner wall, and the annular outer wall and the annular inner wall are both perpendicular to the limiting plane; the adjustment joint is movably arranged on an inner side of the annular outer wall and can be biased against the limiting plane.

12. The dual-function water spray nozzle according to claim 11, characterized in that, an inner sidewall of the annular inner wall is provided with a second inner connection portion, and an end of the fixation member away from the restriction surface is provided with a second outer connection portion, and the second inner connection portion and the second outer connection portion are connected to each other to connect the fixation member to the housing; or
an inner sidewall and an outer sidewall of an end of the annular outer wall away from the adjustment assembly are respectively provided with a first inner connection portion and a first outer connection portion, and an upper end surface of the limiting plane is provided with a gasket, the first inner connection portion is connected to an external part and sealed through the gasket, or the first outer connection portion is connected to the external part.

13. The dual-function water spray nozzle according to claim 6, characterized in that, the fixation member is provided with a plurality of adjustment holes, a water flow passage area of the adjustment holes matches a water flow passage area of the aerator of the first water outlet; after the adjustment joint is assembled in the dual-function water spray nozzle, the elastic member is compressed and thereby generates a preloading force, and when water flow is introduced a water inflow rate of the fixation member is set to be greater than a water outflow rate of the first water outlet, causing an internal pressure to form in the first flow passage region, and when the internal pressure is greater than a standard atmospheric pressure, the switching member installed with the aerator is arranged to generate a downward pressure along an axial direction of the switching member, and the internal pressure generates an upward thrust on the stop surface and a restriction plane, and when the sum of the upward thrust and the preloading force is greater than the downward pressure, the sum of the upward thrust and the preloading force forces the switching member upward until the said sum of the upward thrust and the preloading force balances with the downward pressure, and thereby maintains the state of the switching member.

14. The dual-function water spray nozzle according to claim 13, characterized in that, when the adjustment joint is pulled downward, the restriction plane contacts the restriction surface, the elastic member is compressed to a maximum extent to generate an upward preloading force on the adjustment assembly; when water is introduced, the water inflow rate of the fixation member is set to be greater than the water outflow rate of the water outlet, the second flow passage region forms an internal pressure and pushes the adjustment assembly downward, the internal pressure offsets the preloading force to keep the adjustment assembly balanced.

15. The dual-function water spray nozzle according to claim 14, characterized in that, when the water inlet is shut off, the internal pressure of the second flow passage region disappears, and the elastic member pushes against the switching member to move upward until the adjustment joint is biased against the limiting plane to stop moving and get restored and maintained thereat.
